(19) United States
(12) Patent Application Publication
(10) Pub. No.: US 2015/0150741 A1
(43) Pub. Date: Jun. 4, 2015

(54) Apparatus and Method for Displacement of Human Body

(71) Applicant: Xiaoming Shi, Shenzhen (CN)

(72) Inventor: Xiaoming Shi, Shenzhen (CN)

(21) Appl. No.: 14/555,740

(22) Filed: Nov. 28, 2014

(30) Foreign Application Priority Data
Dec. 4, 2013 (CN) 201310645888.X

(51) Int. Cl. A61G 7/10

(52) U.S. Cl. CPC A61G 7/1019; A61G 7/1001; A61G 7/1034

(57) ABSTRACT

An apparatus for displacement of a human body is provided, which comprises: a cushion, a height adjustable movable platform, a first lifting mechanism, a guide rail assembly and a roller assembly. The first lifting mechanism is arranged on the cushion and is configured for lifting or lowering the cushion. One end of the guide rail assembly is positioned on the movable platform, wherein the guide rail assembly includes at least one guide rail. The at least one guide rail is simultaneously positioned under the cushion in a horizontal direction or a longitudinal direction at least in part. The roller assembly is arranged between the guide rail and the bottom of the cushion, in such a way that the cushion is capable of sliding to or off the movable platform along the guide rail.

### CROSS REFERENCE TO RELATED PATENT APPLICATIONS

The present patent application claims benefit of Chinese patent application No. 201310645888.X filed on Dec. 4, 2013, the entire contents are incorporated by reference.

### TECHNICAL FIELD

The present application relates to an apparatus and a method for displacement of a human body, and more specifically, relates to an apparatus and a method for displacing a disabled or mobility-impaired person.

### BACKGROUND

For a disabled or mobility-impaired person, especially for a disabled person whose legs or limbs are weak, it is difficult to change his or her position without any assisting means, when he or she wants to move to a wheelchair or get in a car. Generally, it needs at least two adults to assist with the position changing, which is a hard work for his or her families. Therefore, usually the disabled or mobility-impaired person avoids from changing his or her position or travelling. And thus activities of the disabled or mobility-impaired person are restricted. Furthermore, the disabled or mobility-impaired person may be injured when changing his or her position.

### SUMMARY

To solve the drawbacks in prior art, the present application provides an apparatus and a method for displacement of a human body. The apparatus has a simple structure, and is reliable and convenient to carry. And the method is convenient for displacing the disabled or mobility-impaired person.

In one respect, an apparatus for displacement of a human body is provided. Wherein, the apparatus for displacement of a human body comprises a cushion, a height adjustable movable platform, a first lifting mechanism, a guide rail assembly and a roller assembly. The first lifting mechanism is arranged on the cushion and is configured for lifting or lowering the cushion. One end of the guide rail assembly is positioned on the movable platform, wherein the guide rail assembly includes at least one guide rail. The at least one guide rail is simultaneously positioned under the cushion in a horizontal direction or a longitudinal direction at least in part. The roller assembly is arranged between the guide rail and the bottom of the cushion, in such a way that the cushion is capable of sliding to or off the movable platform along the guide rail.

In one embodiment, the cushion includes a cushion body and a base plate. Wherein, one end of the first lifting mechanism is fixedly connected to the cushion body and the other end thereof is fixed to the base plate. The roller assembly is arranged along a periphery of the bottom of the cushion body. A bottom of the roller assembly is located above the base plate in a vertical direction. A height difference between the bottom of the roller assembly and the base plate is changed by adjusting the lifting mechanism.

In one embodiment, the roller assembly includes a first set of rollers that is located in the horizontal direction at the bottom of the cushion body, and a second set of rollers that is located in the longitudinal direction at the bottom of the cushion body. Wherein, the first set of rollers and the second set of rollers are arranged around the first lifting mechanism, and the first set of rollers and the second set of rollers respectively include at least two pairs of non-steered rollers.

In another embodiment, the apparatus includes two first lifting mechanisms. Wherein, the two first lifting mechanisms are detachably mounted on two sides of the cushion respectively. Each of the first lifting mechanisms includes a gear, a rack, a control rod and a lifting plate. Wherein, the gear is mounted on the cushion. One end of the control rod is connected to the gear for motion transmission, and the gear is engaged with the rack. The lifting plate is arranged on the bottom of the cushion, and is fixedly connected to the rack. The lifting plate is movable in the vertical direction driven by the control rod in such a way that the cushion is lifted or lowered.

In this embodiment, the first lifting mechanism may further include a baffle and a first locking unit. Wherein, one end of the baffle is vertically and detachably mounted on the cushion body. The first locking unit includes a stopping rod and a first locking latch. Wherein, the stopping rod is fixed to the other end of the baffle, and the first locking latch is rotatably arranged on the other end of the control rod. The first locking latch is locked on the stopping rod after being rotated a preset angle.

In this embodiment, the first lifting mechanism further includes a gear housing detachably mounted on the cushion, and the gear and the rack are mounted in the gear housing. Projections protruding in a direction away from the axis of the gear housing are formed on two sides of the gear housing. A threaded hole is defined in each of the projections. In this case, the projections are located in the middle of the gear housing in the vertical direction.

In this embodiment, the cushion includes a cushion body and a plurality of stopping blocks. Wherein, the plurality of stopping blocks are distributed and separated in the horizontal direction and the longitudinal direction at the bottom of the cushion body. A plurality of guiding slots configured to hold the guide rails inserted are formed between the plurality of stopping blocks.

In this embodiment, the roller assembly includes a plurality of rollers that is separately arranged along the longitudinal direction of the guide rail. The guide rail assembly further includes a second locking unit which is arranged at one end of the guide rail. Wherein, the second locking unit includes an engaging portion that is engaged with the movable platform. The engaging portion is located at outside of the guide rail, and a locking hole is defined in the engaging portion.

The second locking unit further includes a rotor which is rotatably inserted in one side of the guide rail. A rotary switch is fixed in the front of the rotor, and a second locking latch is sleeved on the rotor. A groove for receiving the second locking latch is defined on the surface of the guide rail that is close to the engaging portion. The second locking latch is rotated and then inserted into the locking hole when the rotary switch is rotated.

In this embodiment, the guide rail assembly includes two guide rails, and the two guide rails are connected to each other by a foldable connecting rod. The connecting rod includes a first sub-rod and a second sub-rod. Wherein, one end of the first sub-rod is connected to one of the guide rails, and one end of the second sub-rod is connected to the other of the guide rails. The other end of the first sub-rod is movably connected to the other end of the second sub-rod.

In this embodiment, the movable platform includes: a base station configured for carrying the cushion, a base configured for displacing the base station, and a second lifting mechanism. In this case, the base includes universal wheels arranged at the bottom of the base. One end of the second lifting mechanism is height-adjustably connected to the bottom of the base station, and the other end thereof is fixed to the base.

In this embodiment, a plurality of stopping elements are arranged on the base station for preventing the guide rails from sliding off the base station.

A guide plate is provided between the base station and the second lifting mechanism. Wherein, at least one guide pillar and at least one guide bushing sleeved on the corresponding guide pillar are arranged in the guide plate.

Preferably, the first lifting mechanism and the second lifting mechanism comprise a mechanical jack, a hydraulic jack, an electric jack or a cylinder.

In another aspect, a method for the displacement of a human body is provided, which comprises the following steps:

In step S1, a cushion is positioned under the human body when the human body is in an initial position. A movable platform is displaced to a position close to the initial position. A height of the movable platform is further adjusted so that the surface of the movable platform is substantially at a same level as the initial position.

In step S2, a moving direction of the human body is determined according to the initial position and orientation of the human body. The height of the cushion is adjusted by a first lifting mechanism in such a way that one end of a guide rail of a guide rail assembly is inserted under the cushion in a horizontal direction or a longitudinal direction, and the other end of the guide rail is positioned in the initial position. The height of the cushion is further adjusted by the first lifting mechanism in such a way that the cushion is completely supported on the guide rail assembly via a roller assembly.

In step S3, the cushion is displaced from the initial position to the movable platform. The cushion is lifted by the first lifting mechanism so that the guide rail is pulled out.

In step S4, the movable platform is displaced to a position close to a target position. The height of the movable platform is adjusted so that the surface of the movable platform is substantially at a same level as the target position.

In step S5, a moving direction of the human body is determined according to the initial position and the orientation of the human body. The height of the cushion is adjusted by a first lifting mechanism in such a way that one end of a guide rail is inserted under the cushion in the horizontal direction or the longitudinal direction. And the other end of the guide rail is positioned in the target position. The height of the cushion is further adjusted by the first lifting mechanism in such a way that the cushion is completely supported on the guide rail assembly via the roller assembly.

In step S6, the cushion is displaced from the movable platform to the target position. The cushion is lifted by the first lifting mechanism so that the guide rail is pulled out; the cushion is further lowered so that the cushion is pulled out.

In one embodiment, the cushion includes a cushion body and a base plate, one end of the first lifting mechanism is fixedly connected to the cushion body and the other end thereof is fixed to the base plate. The roller assembly includes a first set of rollers that is located in the horizontal direction at the bottom of the cushion body and a second set of rollers that is located in the longitudinal direction at the bottom of the cushion body.

In this embodiment, the step S2 includes: the cushion body is lifted by the first lifting mechanism until a height difference between the bottom of the roller assembly and the base plate is larger than the thickness of the guide rail of the guide rail assembly. One end of the guide rail that is positioned in the initial position is extended under the first set of rollers in the horizontal direction of the roller assembly. And the cushion body is further lowered until the first set of rollers is contacted with the guide rail assembly. The base plate is lifted off the initial position, thus the cushion is completely supported on the guide rails via the first set of rollers.

In another embodiment, the cushion includes a cushion body, and a plurality of guiding slots formed at the bottom of the cushion in the horizontal direction and the longitudinal direction. The first lifting mechanism includes a lifting plate arranged at the bottom of the cushion, wherein the lifting plate is movable in the vertical direction.

In this embodiment, the step S2 further includes: the cushion body is lifted by the first lifting mechanism until a height difference between a bottom surface of the cushion body and a top surface of the lifting plate is larger than the thickness of the guide rail. After that, one end of the guide rail that is positioned in the initial position is inserted in the guiding slot arranged in the horizontal direction. The cushion body is lowered by the first lifting mechanism until the cushion body is contacted with the roller assembly, thus the cushion is completely supported on the guide rail via the roller assembly.

When implementing the present application, the following advantageous effects can be achieved: the cushion is capable of being sliding along the guide rail positioned between the initial position and the movable platform, or between the movable platform and the target position. In this way, the human body is easy to be displaced from the initial position to the target position. During the displacement process, one adult may carry out the displacement easily, since less external force is need (the force is need only during the process of positioning the cushion under the human body and pushing the cushion to slide along the guide rail). Therefore, the displacement of the human body is safe and fast, and the disabled or mobility-impaired person who is displaced may not be injured. Besides, the configuration of the apparatus is simple, and is convenient for carry.

### BRIEF DESCRIPTION OF THE DRAWINGS

The present application will be further described with reference to the accompanying drawings and embodiments in the following, in the accompanying drawings:

FIG. 1 illustrates an apparatus for displacement of a human body according to a first embodiment of the present application;

FIG. 2 is a bottom view of a cushion shown in FIG. 1;

FIG. 3 is a top view of a guide rail assembly shown in FIG. 1;

FIG. 4 is a schematic diagram showing the apparatus for displacement of the human body, wherein a first lifting mechanism is in a compressed state;

FIG. 5 is a schematic diagram showing the apparatus for displacement of the human body, wherein the first lifting mechanism is in a lifting state;

FIG. 6 illustrates another embodiment of a movable platform according to the present application;

FIG. 7 illustrates an apparatus for displacement of a human body according to a second embodiment of the present application;

FIG. 8 is a side view of the apparatus for displacement of a human body shown in FIG. 7;

FIG. 9 is a schematic diagram showing the cushion being assembled with the first lifting mechanism shown in FIG. 7;

FIG. 10 is a schematic diagram showing the cushion being assembled with the first lifting mechanism according to another embodiment of the present application;

FIG. 11 is a side view of the cushion and the lifting mechanism shown in FIG. 10;

FIG. 12 is a schematic diagram showing the guide rail assembly of FIG. 7; and

FIG. 13 is a schematic diagram showing a mounting base according to the present application.

### DETAILED DESCRIPTION

To explain the objects, the technical solutions and the advantages of the present application more clearly, the present application will be further described with reference to the accompanying drawings and embodiments in the following. It should be understood that, the specific embodiments described here are only for explanation, but not for limitation to the present application.

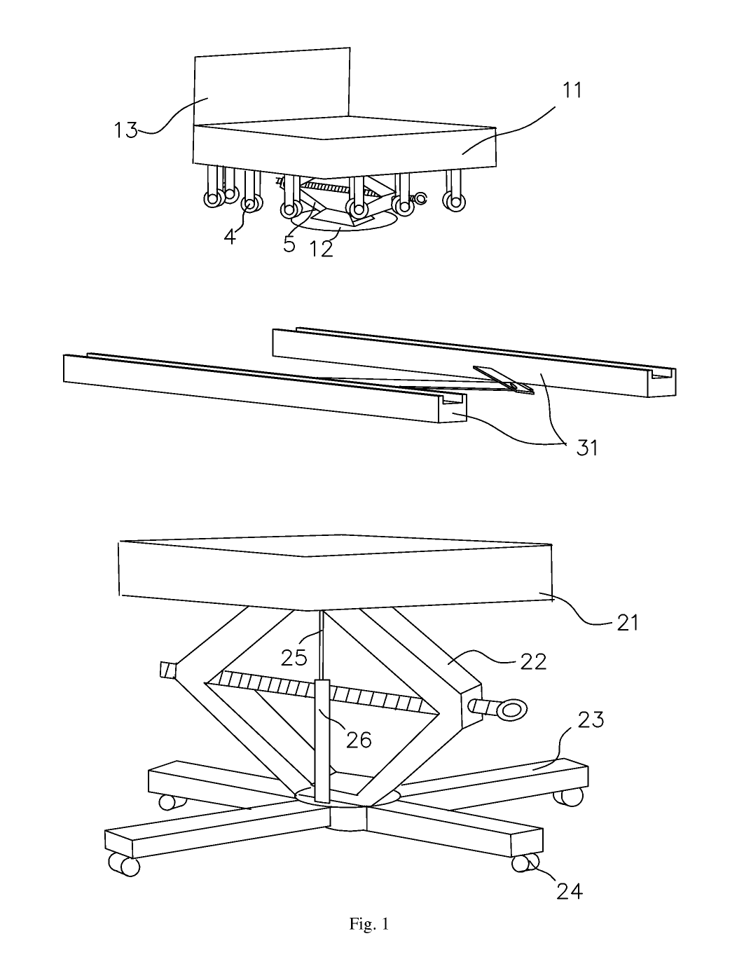

FIGS. 1-5 illustrate an apparatus for displacement of a human body according to a first embodiment of the present application. The apparatus for displacement of a human body is configured for displacing a disabled or mobility-impaired person from an initial position to a target position. As shown in FIG. 1, the apparatus comprises a cushion 1 configured for carrying a human body, a height-adjustable movable platform 2 configured for transferring the cushion 1, and a guide rail assembly 3. The guide rail assembly 3 includes at least one guide rail 31. Each of the at least one guide rail 31 is simultaneously positioned under the cushion 1 in a horizontal direction or a longitudinal direction at least in part. In the embodiment as shown in FIG. 1, the guide rail assembly 3 includes two guide rails 31. Wherein, one end of each of the guide rails 31 is arranged on the movable platform 2, and the other end thereof is positioned on the initial position or the target position. In this way, the cushion 1 may be displaced from the initial position to the movable platform 2, or from the movable platform 2 to the target position along the guide rail assembly 3. The apparatus further comprises a roller assembly 4 that is cooperated with the guide rail assembly 3 such that the cushion 1 is capable of sliding, and a first lifting mechanism 5 that is configured for lifting or lowering the cushion 1. In this case, the roller assembly 4 is arranged along the periphery of the bottom of the cushion 1, while the first lifting mechanism 5 is arranged at the center of the bottom of the cushion 1.

When the cushion 1 is lifted by the first lifting mechanism 5, the at least one guide rail 31 is inserted in the horizontal direction or the longitudinal direction under the cushion 1. Then the cushion 1 is further lowered by the first lifting mechanism 5. In this way, the cushion 1 is supported on the guide rail 31 via the roller assembly 4 at the bottom of the cushion 1. And then, by a sliding movement of the roller assembly 4 relative to the guide rail 31, the cushion 1 may be displaced from the initial position to the movable platform 2, or from the movable platform 2 to the target position along the guide rail 31.

FIG. 2 shows the cushion and the roller assembly according to one embodiment of the present application. As shown in FIGS. 1-2, the cushion 1 includes a cushion body 11, and a base plate 12 in shape of a disc. The cushion body 11 is configured for supporting the human body. And the base plate 12 is configured for supporting the cushion body 11 when no movement occurs. Preferably, the cushion 1 may further include an armrest (not shown) and a detachable backrest 13. Wherein, the detachable backrest 13 supports an upper body when the disabled or mobility-impaired person sits up.

Further as shown in FIGS. 1-2, the roller assembly 4 is arranged along the periphery of the bottom of the cushion 1, and the bottom of the roller assembly 4 is located above the base plate 12 in the vertical direction. The roller assembly 4 includes a first set of rollers 41 and a second set of rollers 42. In this case, the first set of rollers 41 is located at the bottom of the cushion body 11 along the horizontal direction. While the second set of rollers 42 is located along the longitudinal direction at the bottom of the cushion body 11.

Specifically, the first set of rollers 41 and the second set of rollers 42 respectively include at least two pairs of non-steered rollers 43 which are parallel to each other. When the cushion 1 needs to be displaced towards different directions, optionally the first set of rollers 41 or the second set of rollers 42 may be chosen to be cooperated with the guide rail assembly 3. That is, the first set of rollers 41 or the second set of rollers 42 may be slid on the guide rail assembly 3. In this way, the rollers 43 of the roller assembly 4 may slide only in one rectilinear direction at a time. And thus, the cushion 1 may be displaced along different directions.

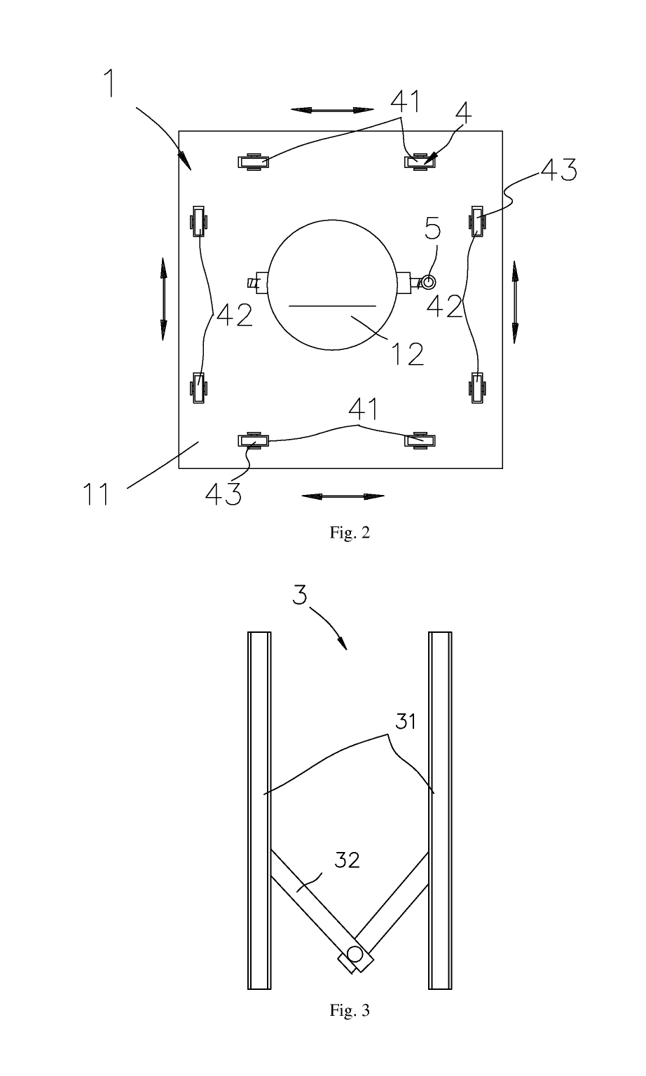

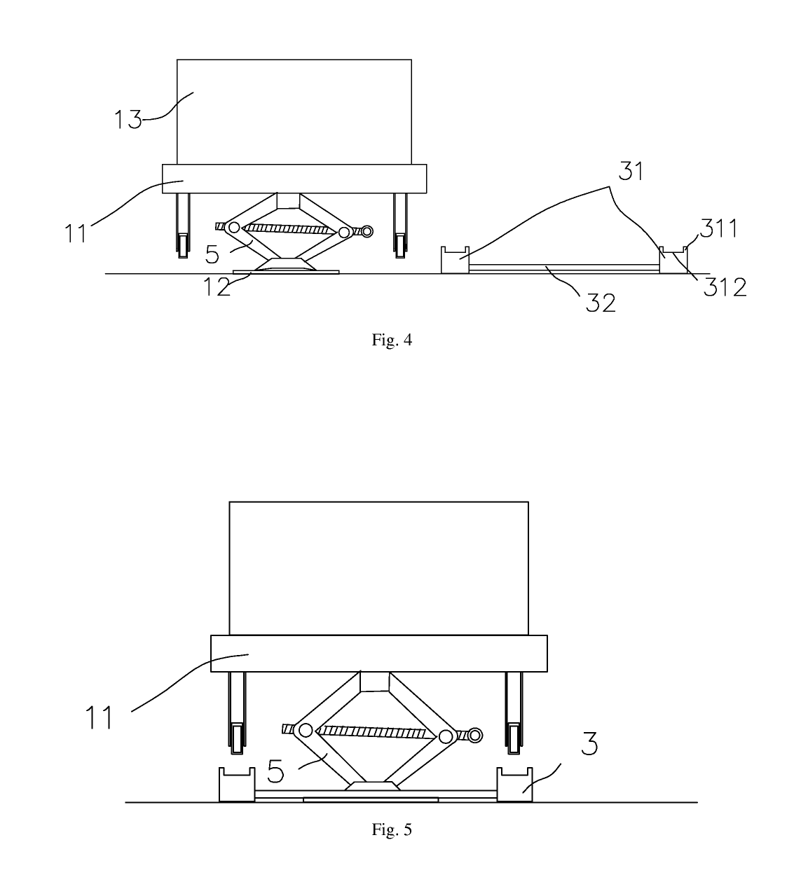

FIGS. 3-4 show the guide rail assembly 3 according to the present application. As shown in FIG. 3, the guide rail assembly 3 includes two guide rails 31 which are parallel to each other. The guide rails 31 are configured for supporting the first set of rollers 41 or the second set of rollers 42 thereon. In this way, the cushion 1 is stably supported on the two guide rails 31, and is further capable of sliding along the two guide rails 31. A foldable connecting rod 32 is connected between the two guide rails 31. Wherein the connecting rod 32 includes a first sub-rod (not labeled) and a second sub-rod (not labeled) that are movably connected to each other at one ends. The other ends of the first sub-rod and the second sub-rod are respectively connected to the two guide rails 31. With the above-mentioned connecting rod 32, the two guide rails 31 may be pulled away from each other with a suitable distance so as to cooperate with the roller assembly 4. Or, the two guide rails 31 may be put together so as to be carried conveniently. It could be understood that, the two guide rails 31 may be separated from each other without the connecting rod 32 connected therebetween.

Furthermore, as shown in FIG. 4, each of the guide rails 31 includes a track 312 along which the rollers 43 of the roller assembly 4 may slide. The guide rail 31 further includes side plates 311 arranged on both sides of the track 312. In this case, a height of the side plate 311 is larger than that of the track 312. And thus, the rollers 43 may be prevented from sliding off the guide rail 31. Preferably, a length of the guide rail 31 is equal to or larger than a sum of the lengths of the cushion 1 and the movable platform 2. Besides, the guide rail 31 is capable of bearing a weight of 200 KG without deformation. Preferably, the guide rails 31 may be made from aluminium alloy or stainless steel.

FIGS. 4-5 show a configuration of the first lifting mechanism 5. As shown in FIGS. 4-5, one end of the first lifting mechanism 5 is fixedly connected to the cushion body 11, and the other end of the first lifting mechanism 5 is fixed to the base plate 12. The first lifting mechanism 5 is configured for adjusting the height difference between the bottom of the roller assembly 4 and the base plate 12. Preferably, in this embodiment, a travel of the first lifting mechanism 5 is approximately 50˜100 mm. In this way, the height difference between the bottom of the roller assembly 4 and the base plate 12 may be smaller or larger than the thickness of the track 312. Preferably, the first lifting mechanism 5 may be a mechanical jack, a hydraulic jack, an electric jack or a cylinder. More preferably, in this embodiment, the first lifting mechanism 5 is a mechanical jack, since a weight thereof is light and the construction costs low.

FIGS. 4-5 further show the apparatus for displacement of the human body when the first lifting mechanism 5 is in different working states. As shown in FIG. 4, when the human body is in the initial position, the cushion 1 is deposited under the human body, and the base plate 12 is contacted with the initial position. At this time, the first lifting mechanism 5 is in a compressed state, a distance between the cushion body 11 and the base plate 12 is only 10 cm. That is, an entire height in the vertical direction of the cushion 1 when it is in the initial position is only 10 cm. When the cushion 1 stays in the initial position, the base plate 12 supports the cushion body 11 and the human body, and the bottom of the roller assembly is located above the base plate 12 in the vertical direction. That is, the roller assembly is suspended. As shown in FIG. 4, since the height difference between the bottom of the roller assembly 4 and the base plate 12 is smaller than the thickness of the track 312, the guide rails can not be inserted under the cushion body 11.

As shown in FIG. 5, when height of the first lifting mechanism 5 is raised, the cushion body 11 and the roller assembly 4 together are lifted. And thus, the guide rail assembly 3 may be positioned under the roller assembly 4, if the height difference between the bottom of the roller assembly 4 and the base plate 12 is larger than the thickness of the track 312. In this case, if the cushion body 11 is further lowered until the roller assembly 4 is contacted with the guide rail assembly 3, and the base plate 12 is lifted off the initial position, the cushion 1 may be completely supported on the guide rails 31 of the guide rail assembly 3 via the roller assembly 4. In this way, the cushion 1 may be displaced from the initial position to the movable platform 2 along the guide rails 31, or displaced from the movable platform 2 to the target position.

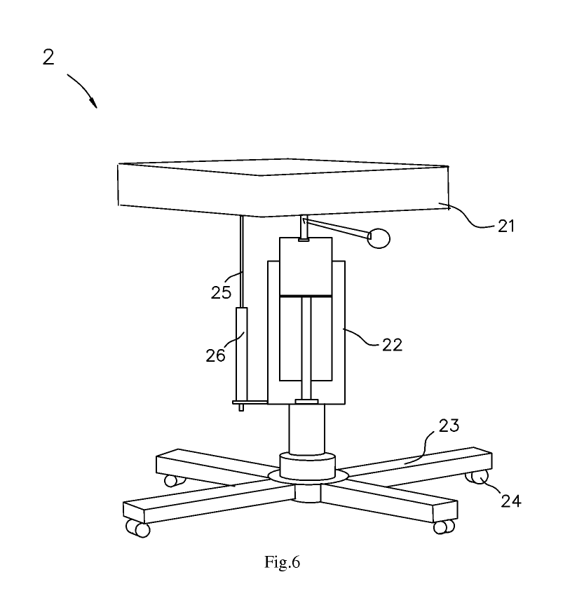

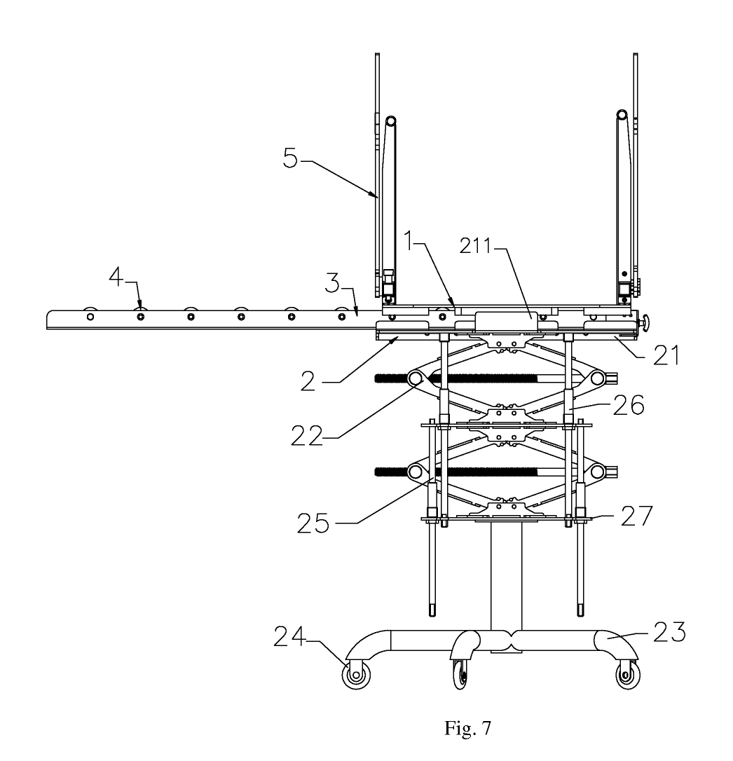

FIGS. 1 and 6 show two different embodiments of the movable platform 2 according to the present application respectively. As shown in FIGS. 1 and 6, in one embodiment, the movable platform 2 includes a base station 21 for carrying the cushion 1, a second lifting mechanism 22 for adjusting a height of the base station 21, and a base 23 for displacing the base station 21. In this case, a plurality of stopping elements (not shown) are arranged around the periphery of the base station 21. And thus, the guide rails 31 are prevented from sliding off the base station 21.

In this case, one end of the second lifting mechanism 22 is height-adjustably connected to the center of the bottom of the base station 21, and the other end of the second lifting mechanism 22 is fixed to the base 23. Preferably, the second lifting mechanism 22 may be a mechanical jack, a hydraulic jack, an electric jack or a cylinder. In the embodiment as shown in FIG. 1, the second lifting mechanism 22 is a mechanical jack. While in the embodiment as shown in FIG. 6, the second lifting mechanism 22 is a hydraulic jack. Furthermore, the second lifting mechanism 22 may be a combination of two mechanical or hydraulic jacks stacked on one another (not shown). In this way, a desire travel (for example, 470 mm) may be achieved, when the height difference between the initial position or the target position and the movable platform 2 is large.

As shown in FIGS. 1 and 6, four brackets are provided on the base 23, wherein a universal wheel 24 is arranged at the bottom of each of the brackets. In this way, the movable platform 2 may be rotated in any directions. In additions, a locking member (not shown) may be further provided on the universal wheel 24. And thus, the universal wheel may be locked and the movable platform 2 is in turn fixed.

Furthermore, as shown in FIGS. 1 and 6, to prevent the base station 21 from shaking, at least one guide pillar 25 may be provided at the bottom of the base station 21. Besides, at least one guide bushing 26 corresponding to the at least one guide pillar 25 may be further provided. The at least one guide bushing 26 is connected to the other end of the second lifting mechanism 22. Preferably, in the cases as shown in FIGS. 1 and 6, one guide pillar 25 is provided. However, six guide pillars 25 distributed around the second lifting mechanism 22 may be provided in other cases. In this case, the guide pillars 25 are cooperated with the corresponding guide bushings 26 so as to support the base station 21.

A working process of the apparatus according to the present embodiment may be briefly described below (e.g. the human body is displaced from the wheelchair to the car seat):
1) When the human body is in the initial position (sitting on the wheelchair), the cushion 1 is positioned under the human body.
2) The height of the movable platform 2 is adjusted, so that the surface of the movable platform 2 is substantially at a same level as the initial position.
3) The cushion 1 is lifted by the first lifting mechanism 5. When the height difference between the bottom of the roller assembly 4 and the base plate 12 is larger than the thickness of the of the track 312, one end of the guide rails 31 is inserted under the first set of rollers 41, and the other end of the guide rails 31 is positioned on the movable platform 2. In this case, the longitudinal direction of the guide rails 31 is parallel to an extension direction of the legs of the human body.
4) The cushion 1 is lowered by the first lifting mechanism 5, so that the first set of rollers 41 are inserted into the track 312. And the cushion 1 is therefore completely supported on the guide rail assembly 3 through the roller assembly 4.
5) The cushion 1 is slid from the initial position to the movable platform 2 along the guide rails 31. And the cushion 1 is lifted again by the first lifting mechanism 5, so that the first set of rollers 41 will not press on the guide rails 31 any longer. And then the guide rails 31 are pulled out.
6) The movable platform 2 is moved to a position close to the target position (car seat). The height of the movable is further adjusted, so that the surface of the movable platform 2 is substantially at a same level as the target position. The orientation of the human body is adjusted (in this case, the human body should be faced toward the driving direction) by rotating the movable platform 2, according to the orientation of the target position (the seat direction).
7) The cushion 1 is lifted again by the first lifting mechanism 5. The guide rails 31 are inserted under the second set of rollers 42. In this way, the human body may be slid in a direction parallel to the seat direction, and the human body is kept facing toward the driving direction.
8) The cushion 1 is lowered by the first lifting mechanism 5, and thus the first set of rollers 41 are inserted into the track 312. The cushion 1 is then completely supported on the guide rail assembly 3 through the roller assembly 4.
9) The cushion 1 is slid from the movable platform 2 to the target position (car seat).
10) The cushion 1 is lifted by the first lifting mechanism 5 again, and the guide rail 31 is then pulled out.
11) The cushion 1 is lowered by the first lifting mechanism 5 until it is contacted with the target position. After that, the cushion 1 is pulled out.

If the human body is displaced from the car seat to the wheelchair, the guide rails 31 should be inserted in a different direction.

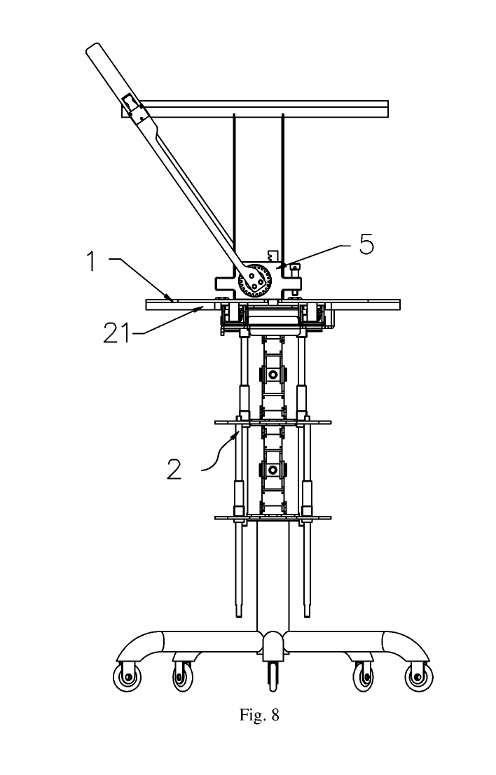

FIGS. 7-13 illustrate an apparatus for displacement of a human body according to a second embodiment of the present application. As shown in FIG. 7, the apparatus comprises a cushion 1, a height adjustable movable platform 2, a guide rail assembly 3, a roller assembly 4 and a first lifting mechanism 5. The guide rail assembly 3 includes at least one guide rail 31. Each of the at least one guide rail 31 is simultaneously positioned under the cushion 1 in the horizontal direction or the longitudinal direction at least in part. One end of the guide rails 31 is engaged with the movable platform 2, and the other end thereof is positioned on the initial position or the target position. In this embodiment, the roller assembly 4 is arranged in the guide rails 31 in the longitudinal direction of the guide rails 31. Besides, there are two first lifting mechanisms 5. The two first lifting mechanisms 5 are detachably mounted on two sides of the cushion 1 respectively, and are configured for lifting or lowering the cushion 1.

When the cushion 1 is lifted by the first lifting mechanism 5, at least one guide rail 31 is inserted in the horizontal direction or the longitudinal direction under the cushion 1. Then the cushion 1 is further lowered by the first lifting mechanism 5. In this way, the cushion 1 is supported on roller assembly 4 in the guide rail 31. After that, the cushion 1 is displaced from the initial position to the movable platform 2 along the guide rail 31, or displaced from the movable platform 2 to the target position via the roller assembly 4.

Specifically, the configuration of the movable platform 2 is similar to that as shown in FIGS. 1 and 6, which includes a base station 21, a second lifting mechanism 22, and a base 23. Wherein, a plurality of universal wheels 24 are arranged at the bottom of the base. Preferably, a plurality of stopping elements 211 are arranged around the periphery of the base station 21. In this way, the guide rails 31 are prevented from sliding off the base station 21.

Preferably, in this embodiment, the second lifting mechanism 22 may be a mechanical jack, a hydraulic jack, an electric jack or a cylinder. Specifically, as shown in FIG. 7, the second lifting mechanism 22 is a mechanical jack. And more preferably, the second lifting mechanism 22 may be a combination of two mechanical jacks stacked on one another.

In addition, as shown in FIG. 7, to prevent the base station 21 from shaking, at least one guide pillar 25 and at least one guide bushing 26 sleeved on the corresponding at least one guide pillar 25 may be provided at the bottom of the base station 21. Besides, at least one guide plate 27 is provided between the base station 21 and the second lifting mechanism 22. The at least one guide pillar 25 is passed through the guide plate 27. Preferably, in the embodiment shown in FIG. 7, four guide pillars are cooperated with the corresponding guide bushings 26 so as to support the base station 21.

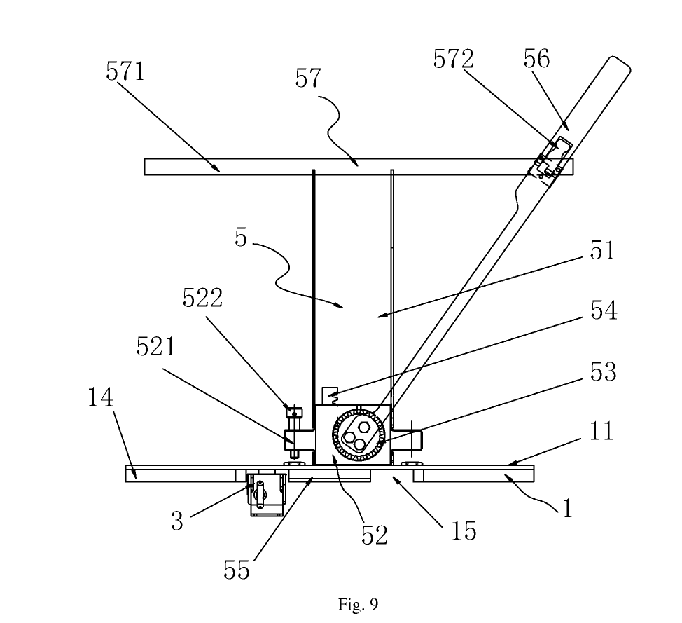

FIG. 9 shows the cushion 1 and the first lifting mechanism 5 according to the present embodiment. In this case, the cushion 1 includes a cushion body 11 configured for supporting the human body, and a plurality of stopping blocks 14 configured for guiding the guide rails 31. A plurality of guiding slots 15 configured to hold the guide rails 31 inserted are formed between the plurality of stopping blocks 14. Particularly, the plurality of stopping blocks 14 are distributed and separated in the horizontal direction and the longitudinal direction at the bottom of the cushion body 11. In this way, the guiding slots 15 are formed in the horizontal direction and the longitudinal direction. And thus, the human body may be displaced in different directions. In this embodiment, two guiding slots 15 are formed in both of the horizontal direction and the longitudinal direction. Preferably, the two guiding slots 15 are symmetrically arranged about a central line of the cushion body 11 so as to improve stability of the cushion 1 during the displacement. It could be understood that, it is possible that only one guiding slot 15 is positioned in both of the horizontal direction and the longitudinal direction. In this case, the guiding slot 15 is arranged at the centre of the cushion body 11.

As shown in FIG. 9, each of the first lifting mechanisms 5 includes a gear 53 mounted on the cushion 1, a rack 54, a lifting plate 55, and a control rod 56. One end of the control rod 56 is connected to the gear 53 for motion transmission, and the gear 53 is engaged with the rack 54. The lifting plate 55 is arranged on the bottom surface of the cushion 1, and is fixed to the rack 54. Therefore, when the control rod 56 is rotated, the gear is rotated along with the control rod, and the rack 54 carries out a linear motion in the vertical direction. In this way, the lifting plate 55 carries out a linear motion in the vertical direction. And thus, the lifting plate 55 may be protruded downward from the cushion body 11 or returned upward to contact with the cushion body 11. And thus, the cushion 1 can be lifted up or lowered down. When the lifting plate 55 is protruded downward from the cushion body 11, the cushion 1 is lifted up via the lifting plate 55. In this case, if the height difference between the bottom surface of cushion body 1 and the top surface of the lifting plate 55 is larger than the height of the guide rail 31, the guide rail 31 may be inserted under the cushion body 11. When the lifting plate is returned upward to contact with the cushion body 11, the whole cushion 1 may be supported on the movable platform 2 or the target position, facilitating the cushion 1 being pulled out.

Furthermore, as shown in FIG. 9, the first lifting mechanism may further include a baffle 51 used as a backrest, and a first locking unit 57 configured for locking the control rod 56. In this case, one end of the baffle 51 is vertically and detachably mounted on the cushion body 11 with bolts or the like.

Specifically, as shown in FIG. 9, the first locking unit 57 includes a stopping rod 571 and a first locking latch 572. In this case, the stopping rod 571 is fixed to the other end (opposite to the end that is mounted on the cushion) of the baffle 51. The first locking latch 572 is rotatably arranged on the other end (opposite to the end that is connected to the gear) of the control rod 56. After the control rod 56 has been rotated to reach a desire position, the first locking latch 572 is rotated a preset angle. Thereby, the first locking latch 572 is locked on the stopping rod 571, and thus the control rod 56 is locked in the desire position. When the first locking latch 572 is counter rotated the same angle, the control rod 56 can be unlocked. Preferably, the preset angle is 90°.

In this embodiment, the first lifting mechanism 5 further includes a gear housing 52 configured for holding the gear 53 and the rack 54. Specifically, as shown in FIG. 9, the gear housing 52 is fixed on the baffle 51 with bolts or the like. And thus, the gear housing 52 is detachably connected to the cushion body 11. The gear 53 and the rack 54 are mounted in the gear housing 52. In this case, projections 521 are formed on two sides of the gear housing 52. Wherein, the projections 521 are protruded in the direction away from the axis of the gear housing 52. A threaded hole (not shown) is defined in each of the projections 521. During the assembly process, a fixing screw 522 runs through the threaded hole, and is finally fixed onto the cushion body 11. In this way, the gear housing 52 may be fixed onto the cushion body 11. Preferably, as shown in FIG. 9, the projections 521 are arranged at a distance from the top surface of the cushion body 11 in the vertical direction. Preferably, the projections 521 are located in the middle of the gear housing in the vertical direction. In this way, it is not easy for the projections 521 to be deformed when the gear housing is fixed to the cushion body. And thus the installation accuracy of the threaded hole and the fixing screw can be ensured.

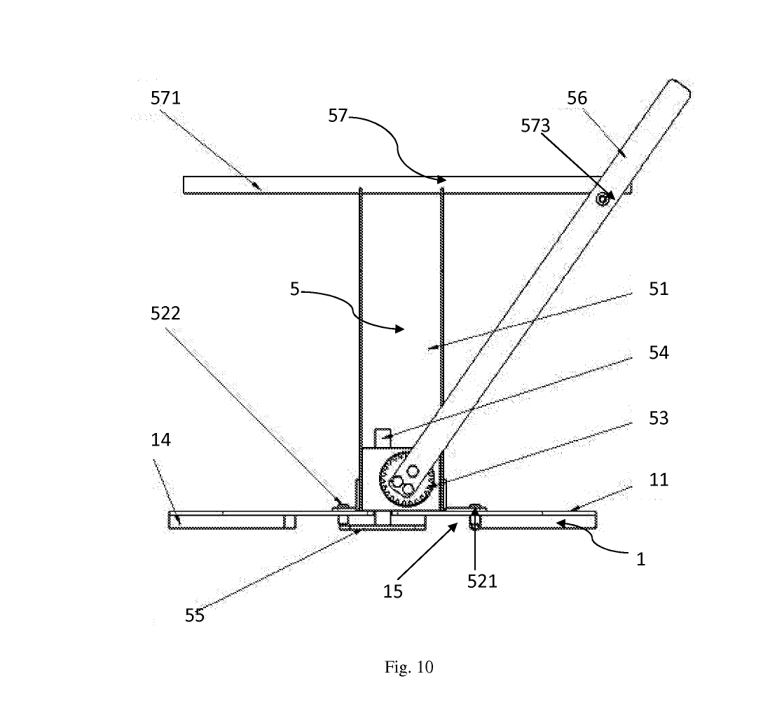

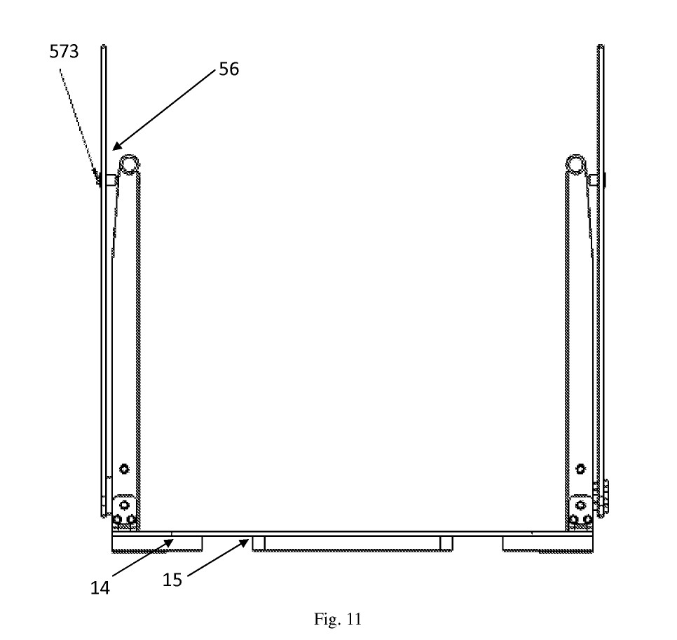

FIGS. 10-11 show a first lifting mechanism 5 according to another embodiment of the present application. It can be seen that, the configuration of the first lifting mechanism 5 in this embodiment is similar to that in the embodiment as shown in FIG. 9. Differences between these two include: the position of the projections 521, and the configuration of the first locking unit 57.

In this embodiment, the projections 521 are located at the lower end of the gear housing 52, and are contacted with the cushion body 11. When the fixing screw 522 runs through the threaded hole and is finally fixed onto the cushion body 11, the bottom surface of the projections 521 are abutted against the cushion body 11. In this way, locking force between the gear housing 52 and the cushion body 11 can be enhanced.

The configuration of the first locking unit 57 may be seen from FIGS. 10-11. As shown in FIGS. 10-11, the first locking unit 57 includes a stopping rod 571 and a locking strut 573. Both ends of the locking strut 573 are provided with flanges, and the locking strut 573 is retractably inserted in the other end of the control rod 56. After the control rod 56 is rotated to reach a desire position, the locking strut 573 may be moved toward the centre of the cushion 1. In this way, the flange of the locking strut 573 may be locked on the stopping rod 571, and thus the control rod 56 may be locked in the desire position. When the locking strut 573 is moved away from the centre of the cushion 1, the locking strut 573 is released from the stopping rod 571. And thus the control rod 56 may be unlocked. Preferably, threads (not shown) may be defined at both ends of the locking strut, and nuts (not shown) fitting with the threads may also be provided. Therefore, the flanges of the locking strut 573 may be locked on the stopping rod 571 by adjusting the position of the nuts.

The lifting process and the lowering process of the cushion 1 with the aid of the first lifting mechanism 5 are briefly described as follow.

Lifting process: when the control rod 56 is rotated manually, the gear 53 is rotated, and the rack 54 and the lifting plate 55 are moved downward in the vertical direction. In this way, the lifting plate 55 is protruded from the cushion body 11, and thus the cushion 1 is lifted. When the cushion 1 is lifted to the desired position, the control rod 56 may be locked by the first locking unit 57. During the lifting process, the height difference between the bottom surface of cushion body 1 and the top surface of the lifting plate 55 may be controlled to be larger than the height of the guide rail 31, so that the guide rails 31 may be inserted under the cushion body 11.

Lowering process: the control rod 56 is unlocked, and is counter rotated, so that the gear 53 is counter rotated, and the rack 54 and the lifting plate 55 are moved upward in the vertical direction. In this way, the cushion 1 is lowered. And thus, the cushion body 11 is supported on the roller assembly 4 or on the initial position or the target position.

The embodiments of the first lifting mechanism described above are just for explanation, not for limitation. It could be understood that, in other cases, the lifting mechanism 5 may be a mechanical jack, a hydraulic jack, an electric jack or a cylinder.

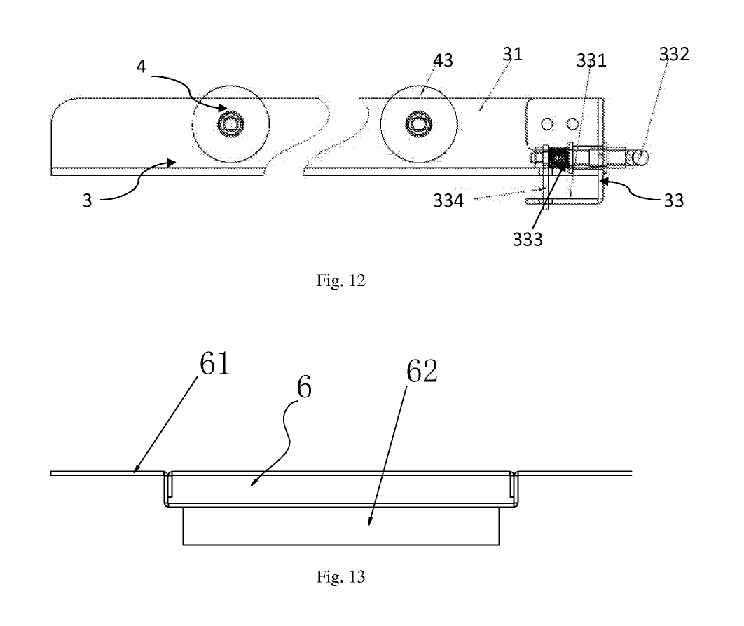

FIG. 12 shows a guide rail assembly 3 and a roller assembly 4 according to an embodiment of the present application. In this embodiment, the roller assembly 4 includes a plurality of non-steered rollers 43 that is separately arranged in the guide rail 31 along the longitudinal direction thereof. After the guide rail 31 is inserted under the cushion body 11, the cushion 1 may be supported by the rollers 43 and may be slid along the guide rail 31 with the help of the rollers 43. Preferably, the length of the guide rail 31 is equal to or larger than a sum of the lengths of the cushion and the movable platform 2. Besides, the guide rail 31 is capable of bearing a weight of 200 KG without deformation. Preferably, the guide rail 31 may be made from aluminium alloy or stainless steel.

As shown in FIG. 12, the guide rail assembly 3 further includes a second locking unit 33. In this case, the second locking unit 33 is arranged at one end of the guide rail 31, and includes an engaging portion 331 that is engaged with the movable platform 2. The engaging portion 331 is of an “L” shape, and is located at outside of the guide rail 31. A locking hole (not labeled) is further defined in the engaging portion 331.

The second locking unit 33 further includes a rotor 333 which is rotatably inserted in one side of the guide rail 31. In this case, a rotary switch 332 is fixed in the front of the rotor 333, and a second locking latch 334 is sleeved on the rotor 333. A groove (not labeled) for receiving the second locking latch 334 is defined on the surface of the guide rail 31 that is close to the engaging portion 331.

Therefore, when the guide rail 31 needs to be fixed to the movable platform 2, the rotary switch 332 is rotated, and then the second locking latch 334 is rotated in the groove and extends to the outside of the guide rail. In this way, the second locking latch 334 is in turn inserted in the locking hole of the engaging portion 331. While the guide rail 31 needs to be disassembled from the movable platform 2, the rotary switch 332 is counter rotated. Therefore, the second locking latch 334 is withdrawn from the locking hole and is returned back into the guide rail 31.

Preferably, in this embodiment, the guide rail assembly 3 may include two guide rails 31 parallel to each other, so that the cushion 1 may be stably supported on the guide rail assembly 3. Preferably, the two guide rails 31 are connected to each other with a foldable connecting rod (not shown). In this way, the distance between the two guide rails 31 may be adjusted as required. The two guide rails 31 may be put together with the connecting rod when being not in use. In this way, the guide rails 31 may be carried conveniently. It could be understood that, the two guide rails may be separated from each other without a connecting rod 32 connected therebetween.

If the surface of the initial position or the target position is inclined or soft, the distance between the cushion body 11 and the lifting plate 55 can not be ensured, and the guide rail 31 can not be inserted. Therefore, the apparatus according to the present application further includes a mounting base 6. As shown in FIG. 13, the mounting base includes an even mounting plate 61 and a height increasing pad 62 fixedly connected to the mounting plate 61. The mounting plate 61 is made from rigid material, while the height increasing pad 62 is preferably made from plastic material. During the displacement of the human body, firstly the mounting base 6 is positioned in the initial position or the target position, so that an even mounting surface can be achieved. Then the cushion 1 is positioned on the mounting plate 61. In this way, the rigid mounting plate 61 ensures the distance between the cushion body 11 and the lifting plate 55, and thus the guide rail assembly 3 can be inserted.

The working process of the apparatus according to the present embodiment may be briefly described below (e.g. the human body is displaced from the wheelchair to the car seat):
1) When the human body is in the initial position (sitting on the wheelchair), the cushion 1 is positioned under the human body. The first lifting mechanisms 5 are assembled with the cushion 1. Wherein, the two baffles 51 are positioned in the front side and the rear side of the human body.
2) The height of the movable platform 2 is adjusted. And thus the surface of the movable platform 2 is substantially at the same level as the initial position.
3) The cushion 1 is lifted by the first lifting mechanism 5. When the height difference between the bottom surface of cushion body 1 and the top surface of the lifting plate 55 is larger than the thickness of the of the track 312, the two guide rails 31 are deposited on the movable platform 2 (specifically, inserted between the stopping block 211 on the base station 21), and are further extended to the position below the cushion body 11. In this case, the longitudinal direction of the guide rails 31 is parallel to the extension direction of the legs of the human body.
4) The cushion 1 is lowered by the first lifting mechanism 5, so that the cushion 1 is completely supported on the roller assembly 4 in the guide rails 31.
5) The cushion 1 is slid from the initial position to the movable platform 2 along the guide rails 31. After that, the cushion 1 is lifted again by the first lifting mechanism 5, so that the first set of rollers 41 will not press on the guide rails 31 any longer. After that, guide rails 31 are pulled out.
6) The movable platform 2 is moved to a position close to the target position (car seat), and then the height of the movable platform 2 is adjusted, so that the surface of the movable platform 2 is substantially at the same level as the target position. The orientation of the human body is adjusted (in this case, the human body should be faced toward the driving direction) by rotating the movable platform 2, according to the orientation of the target position (the seat direction).
7) The cushion 1 is lifted again by the first lifting mechanism 5, and the cushion 1 will not press on the rollers 43 any longer. Then the guide rails 31 are pulled out and inserted under the cushion 1 in a different direction. In this way, the human body may be slid in a direction parallel to the seat direction, and the human body is kept facing toward the driving direction.
8) The cushion 1 is lowered by the first lifting mechanism 5, and thus the cushion 1 is completely supported on the roller assembly 4 in the guide rail assembly 3.
9) The cushion 1 is slid from the movable platform 2 to the target position (the car seat).
10) The cushion 1 is lifted by the first lifting mechanism 5 again, and the guide rail 31 is then pulled out.
11) The cushion 1 is lowered until it is contacted with the target position. Then the first lifting mechanism 5 is disassembled. After that, the cushion 1 is pulled out.

If the human body needs to be displaced from the car seat to the wheelchair, the guide rail 31 should be inserted in a different direction.

After the displacement of the human body is finished, the apparatus may be folded together, and thus the apparatus is convenient for carry.

The present application further provides a method for displacement of a human body, which is used for displacing a disabled or mobility-impaired person from an initial position to a target position. The method comprises the following steps:

In step S1, when the human body is in the initial position, the cushion 1 is positioned under the human body. The movable platform 2 is displaced to a position close to the initial position, and the height of the movable platform 2 is adjusted, so that the surface of the movable platform 2 is substantially at the same level as the initial position.

In step S2, the moving direction of the human body is determined according to the initial position and the orientation of the human body. The height of the cushion 1 is adjusted by the first lifting mechanism 5. In this way, one end of the guide rails 31 may be arranged under the cushion 1 in the horizontal direction or the longitudinal direction, and the other end of the guide rails 31 is positioned in the initial position. The height of the cushion 1 is further adjusted by the first lifting mechanism 5 so that the cushion 1 is completely supported on the guide rail assembly 3 via the roller assembly 4.

In step S3, the cushion 1 is displaced from the initial position to the movable platform 2. The guide rails 31 are then pulled out after the cushion 1 is lifted again.

In step S4, the movable platform 2 is displaced to the position close to the target position. The height of the movable platform is further adjusted, so that the surface of the movable platform 2 is substantially at the same level as the target position.

In step S5, the moving direction of the human body is determined according to the initial position and the orientation of the human body. The height of the cushion 1 is adjusted by the first lifting mechanism 5. In this way, one end of the guide rails 31 may be arranged under the cushion 1 in the horizontal direction or the longitudinal direction, and the other end of the guide rails 31 is positioned in the target position. The height of the cushion 1 is further adjusted, and thus the cushion 1 is completely supported on the guide rail assembly 3 via the roller assembly 4.

In step S6, the cushion 1 is displaced from the movable platform 2 to the target position. The guide rails 31 are then pulled out after the cushion 1 is lifted up again. Finally, the cushion 1 is lowered so as to be pulled out.

Furthermore, since the conditions of the initial position and the target position are different, the orientations and moving directions of the human body should be adjusted as required. In one embodiment of the present application, when the roller assembly 4 is arranged at the bottom of the cushion 1, the guide rails 31 may be cooperated with the first set of rollers 41 in the horizontal direction or the second set of the rollers 42 in the longitudinal direction. Thereby, the moving direction of the human body may be adjusted. In another embodiment of the present application, when the roller assembly 4 is arranged in the guide rails 31, the guide rails 31 may be inserted in the guiding slots positioned in the horizontal direction or the longitudinal direction so as to adjust the moving direction of the human body.

In this case, the step S2 may be achieved by two different manners a and b described below, since the positions of the roller assembly 4 are different.
a. the cushion body 1 are lifted by the first lifting mechanism 5 until the height difference between the bottom of the roller assembly 4 and the base plate 12 is larger than the thickness of the guide rails 31. One end of the guide rails 31 that is positioned in the initial position is extended under the first set of rollers 41 in the horizontal direction of the roller assembly 4. Then the cushion body 11 is lowered by the first lifting mechanism 5 until the first set of rollers 41 are contacted with the guide rail assembly 3, and the base plate 12 is lifted off the initial position. In this way, the cushion 1 is completely supported on the guide rail assembly 3 via the first set of rollers 41.
b. the cushion 1 is lifted by the first lifting mechanism 5 until the height difference between the bottom surface of cushion body 11 and the top surface of the lifting plate 55 is larger than the height of the guide rails 31. One end of the guide rails 31 that is positioned in the initial position is inserted in the guiding slot arranged in the horizontal direction. The cushion body 11 is further lowered until the cushion body 11 is contacted with the roller assembly 4. In this way, the cushion 1 is completely supported on the guide rails 31 via the roller assembly 4.

In the step S5, the guide rails 31 should be arranged in the longitudinal direction under the cushion 1.

According to the apparatus and the method for displacement of the human body in the present application, the cushion is capable of being sliding along the guide rails positioned between the initial position and the movable platform, or between the movable platform and the target position. In this way, the human body is easy to be displaced from the initial position to the target position. During the displacement, one adult may carry out the displacement easily, since less external force is need (the force is need only during the process of positioning the cushion under the human body and pushing the cushion to slide along the guide rail). Therefore, the displacement of the human body is safe and fast, and the disabled or mobility-impaired person who is displaced may not be injured. Besides, the configuration of the apparatus is simple, and is convenient for carry.

It should be understood that, one skilled in the art can make any improvements or modifications which don't depart from the scope of the spirit and the principle of the present application, and these improvements and modifications should be included within the scope of the present application.

1. An apparatus for displacement of a human body, comprising:
a cushion,
a height-adjustable movable platform;
a first lifting mechanism, arranged on the cushion, and configured for lifting or lowering the cushion;
a guide rail assembly, one end of which is positioned on the movable platform, the guide rail assembly including at least one guide rail, and the at least one guide rail being simultaneously positioned under the cushion in a horizontal direction or a longitudinal direction at least in part; and
a roller assembly, arranged between the guide rail and a bottom of the cushion, in such a way that the cushion is capable of sliding to or off the movable platform along the guide rail.

2. The apparatus for displacement of a human body according to claim 1, wherein the cushion includes a cushion body and a base plate, wherein one end of the first lifting mechanism is fixedly connected to the cushion body and the other end thereof is fixed to the base plate; the roller assembly is arranged along a periphery of the bottom of the cushion body; and a bottom of the roller assembly is located above the base plate in a vertical direction; and a height difference between the bottom of the roller assembly and the base plate is changed by adjusting the lifting mechanism.

3. The apparatus for displacement of a human body according to claim 2, wherein the roller assembly includes a first set of rollers that is located in the horizontal direction at the bottom of the cushion body, and a second set of rollers that is located in the longitudinal direction at the bottom of the cushion body, wherein the first set of rollers and the second set of rollers are arranged around the first lifting mechanism, and the first set of rollers and the second set of rollers respectively include at least two pairs of non-steered rollers.

4. The apparatus for displacement of a human body according to claim 1, wherein the apparatus includes two first lifting mechanisms, wherein the two first lifting mechanisms are detachably mounted on two sides of the cushion respectively; each of the first lifting mechanisms includes a gear, a rack, a control rod and a lifting plate, wherein the gear is mounted on the cushion; and
one end of the control rod is connected to the gear for motion transmission, and the gear is engaged with the rack; the lifting plate is arranged on the bottom of the cushion, and is fixedly connected to the rack; the lifting plate is movable in the vertical direction driven by the control rod in such a way that the cushion is lifted or lowered.

5. The apparatus for displacement of a human body according to claim 4, wherein the first lifting mechanism further includes a baffle and a first locking unit; one end of the baffle is vertically and detachably mounted on the cushion body; and
the first locking unit includes a stopping rod and a first locking latch, wherein the stopping rod is fixed to the other end of the baffle, and the first locking latch is rotatably arranged on the other end of the control rod; and the first locking latch is locked on the stopping rod after being rotated a preset angle.

6. The apparatus for displacement of a human body according to claim 4, wherein the first lifting mechanism further includes a gear housing detachably mounted on the cushion, and the gear and the rack are mounted in the gear housing;
projections protruding in a direction away from the axis of the gear housing are formed on two sides of the gear housing, and a threaded hole is defined in each of the projections; the projections are located in the middle of the gear housing in the vertical direction.

7. The apparatus for displacement of a human body according to claim 4, wherein the cushion includes a cushion body and a plurality of stopping blocks, wherein the plurality of stopping blocks are distributed and separated in the horizontal direction and the longitudinal direction at the bottom of the cushion body, and a plurality of guiding slots configured to hold the guide rails inserted are formed between the plurality of stopping blocks.

8. The apparatus for displacement of a human body according to claim 4, wherein the roller assembly includes a plurality of rollers that is separately arranged along the longitudinal direction of the guide rail;
the guide rail assembly further includes a second locking unit which is arranged at one end of the guide rail, wherein the second locking unit includes an engaging portion that is engaged with the movable platform; the engaging portion is located at outside of the guide rail, and a locking hole is defined in the engaging portion;
the second locking unit further includes a rotor which is rotatably inserted in one side of the guide rail; a rotary switch is fixed in the front of the rotor, and a second locking latch is sleeved on the rotor, a groove for receiving the second locking latch is defined on the surface of the guide rail that is close to the engaging portion;
the second locking latch is rotated and then inserted into the locking hole when the rotary switch is rotated.

9. The apparatus for displacement of human body according to claim 8, wherein the guide rail assembly includes two guide rails, and the two guide rails are connected to each other by a foldable connecting rod; the connecting rod includes a first sub-rod and a second sub-rod, wherein one end of the first sub-rod is connected to one of the guide rails, and one end of the second sub-rod is connected to the other of the guide rails; the other end of the first sub-rod is movably connected to the other end of the second sub-rod.

10. The apparatus for displacement of a human body according to claim 1, wherein the movable platform includes:
a base station, configured for carrying the cushion;
a base, configured for displacing the base station, wherein the base includes universal wheels arranged at the bottom of the base; and
a second lifting mechanism, wherein one end of the second lifting mechanism is height-adjustably connected to the bottom of the base station, and the other end thereof is fixed to the base.

11. The apparatus for displacement of a human body according to claim 10, wherein a plurality of stopping elements are arranged on the base station for preventing the guide rail from sliding off the base station;
a guide plate is provided between the base station and the second lifting mechanism, wherein at least one guide pillar and at least one guide bushing sleeved on the corresponding guide pillar are arranged in the guide plate.

12. The apparatus for displacement of a human body according to claim 10, wherein the first lifting mechanism and the second lifting mechanism comprise a mechanical jack, a hydraulic jack, an electric jack or a cylinder.

13. A method for displacement of a human body, comprising:
S1, positioning a cushion under the human body when the human body is in an initial position, and displacing a movable platform to a position close to the initial position, and further adjusting a height of the movable platform so that the surface of the movable platform is substantially at a same level as the initial position;
S2, determining a moving direction of the human body according to the initial position and orientation of the human body, adjusting the height of the cushion by a first lifting mechanism in such a way that one end of a guide rail of a guide rail assembly is inserted under the cushion in a horizontal direction or a longitudinal direction, and the other end of the guide rail is positioned in the initial position, and further adjusting the height of the cushion by the first lifting mechanism in such a way that the cushion is completely supported on the guide rail assembly via a roller assembly;
S3, displacing the cushion from the initial position to the movable platform; and lifting the cushion by the first lifting mechanism so that the guide rail is pulled out;
S4, displacing the movable platform to a position close to a target position, and adjusting the height of the movable platform so that the surface of the movable platform is substantially at a same level as the target position;
S5, determining a moving direction of the human body according to the initial position and the orientation of the human body, adjusting the height of the cushion by a first lifting mechanism in such a way that one end of a guide rail is inserted under the cushion in the horizontal direction or the longitudinal direction, and the other end of the guide rail is positioned in the target position, and further adjusting the height of the cushion by the first lifting mechanism in such a way that the cushion is completely supported on the guide rail assembly via the roller assembly;
S6, displacing the cushion from the movable platform to the target position, lifting the cushion by the first lifting mechanism so that the guide rail is pulled out, and then lowering the cushion so that the cushion is pulled out.

14. The method for displacement of a human body according to claim 13, wherein the cushion includes a cushion body and a base plate, one end of the first lifting mechanism is fixedly connected to the cushion body and the other end thereof is fixed to the base plate; the roller assembly includes a first set of rollers that is located in the horizontal direction at the bottom of the cushion body and a second set of rollers that is located in the longitudinal direction at the bottom of the cushion body;
the step S2 includes:
lifting the cushion body by the first lifting mechanism until a height difference between the bottom of the roller assembly and the base plate is larger than the thickness of the guide rail of the guide rail assembly; extending one end of the guide rail that is positioned in the initial position under the first set of rollers in the horizontal direction of the roller assembly, and further lowering the cushion body until the first set of rollers are contacted with the guide rail assembly, and the base plate is lifted off the initial position, thus the cushion is completely supported on the guide rails via the first set of rollers.

15. The method for displacement of a human body according to claim 13, wherein the cushion include a cushion body, and a plurality of guiding slots formed at the bottom of the cushion in the horizontal direction and the longitudinal direction; the first lifting mechanism includes a lifting plate arranged at the bottom of the cushion, wherein the lifting plate is movable in the vertical direction;
the step S2 includes:
lifting the cushion body by the first lifting mechanism until a height difference between a bottom surface of the cushion body and a top surface of the lifting plate is larger than the thickness of the guide rail, then inserting one end of the guide rail that is positioned in the initial position in the guiding slot arranged in the horizontal direction, and then lowering the cushion body by the first lifting mechanism until the cushion body is contacted with the roller assembly, thus the cushion is completely supported on the guide rail via the roller assembly.
